(19) United States
(12) Patent Application Publication
(10) Pub. No.: US 2018/0375118 A1
(43) Pub. Date: Dec. 27, 2018

(54) LIQUID ELECTROLYTE FUEL CELL COMPONENT WITH INCREASED ELECTROLYTE STORAGE CAPACITY

(71) Applicant: DOOSAN FUEL CELL AMERICA, INC., South Windsor, CT (US)

(72) Inventors: Timothy W. Patterson, JR., West Hartford, CT (US); Eric Livaich, South Windsor, CT (US)

(21) Appl. No.: 15/634,387

(22) Filed: Jun. 27, 2017

(51) Int. Cl. H01M 8/0293; H01M 8/086; H01M 4/86

(52) U.S. Cl. CPC H01M 8/0293; H01M 2300/0008; H01M 4/8605; H01M 8/086

(57) ABSTRACT

An illustrative example fuel cell component includes an electrode substrate including a plurality of pores. A first portion of the substrate includes a liquid electrolyte absorbing material in at least some of the pores in the first portion. Those pores respectively have a first unoccupied pore volume. Pores in a second portion of the substrate respectively have a second unoccupied pore volume. The first unoccupied pore volume is less than the second unoccupied pore volume.

### BACKGROUND

Fuel cells produce electricity based on an electrochemical reaction. Some fuel cells include a polymer electrolyte membrane (PEM) while others utilize a liquid electrolyte, such as phosphoric acid. One issue associated with liquid electrolyte fuel cells is that their useful life and power production capabilities depend on sufficient liquid electrolyte. Various attempts have been made at managing the liquid electrolyte to improve fuel cell performance and increase the useful life.

For example, the published application WO 2014/163617 includes a duplicate anode substrate to increase acid storage capacity at the beginning of life of a fuel cell. Even with such additional storage capacity at the beginning of fuel cell life, evaporation of the liquid electrolyte remains a concern as that presents a source of loss of available electrolyte over time.

### SUMMARY

An illustrative example fuel cell component includes an electrode substrate including a plurality of pores. A first portion of the substrate includes a liquid electrolyte absorbing material in at least some of the pores in the first portion. Those pores respectively have a first unoccupied pore volume. Pores in a second portion of the substrate respectively have a second unoccupied pore volume. The first unoccupied pore volume is less than the second unoccupied pore volume.

In an example embodiment having one or more features of the fuel cell component of the previous paragraph, the liquid electrolyte absorbing material comprises carbon.

In an example embodiment having one or more features of the fuel cell component of either of the previous paragraphs, the liquid electrolyte absorbing material comprises graphite.

In an example embodiment having one or more features of the fuel cell component of any of the previous paragraphs, the first portion of the substrate is impregnated with the liquid electrolyte absorbing material.

In an example embodiment having one or more features of the fuel cell component of any of the previous paragraphs, the pores in the second portion of the substrate have an average pore size of about 20 μm. The pores in the first portion having the liquid electrolyte absorbing material have an average resulting pore size greater than about 2 μm and less than about 20 μm.

An illustrative example method of making a fuel cell component includes forming a substrate having a plurality of pores. At least a first portion of the substrate is impregnated with a liquid electrolyte absorbing material such that at least some of the pores in the first portion of the substrate respectively have a first unoccupied pore volume. The pores in a second portion of the substrate respectively have a second unoccupied pore volume. The first unoccupied pore volume is less than the second unoccupied pore volume.

In an example embodiment having one or more features of the method of the previous paragraph, the liquid electrolyte absorbing material comprises carbon.

In an example embodiment having one or more features of the method of any of the previous paragraphs, the liquid electrolyte absorbing material comprises graphite.

In an example embodiment having one or more features of the method of any of the previous paragraphs, the pores in the second portion of the substrate have an average pore size of about 20 μm and the pores in the first portion having the liquid electrolyte absorbing material have an average resulting pore size greater than about 2 μm and less than about 20 μm after the impregnating.

An illustrative example fuel cell includes a matrix configured to contain a liquid electrolyte, a cathode electrode on one side of the matrix, an anode electrode on an opposite side of the matrix, and a substrate adjacent the cathode electrode. The substrate has a plurality of pores. A first portion of the substrate includes a liquid electrolyte absorbing material in at least some of the pores in the first portion of the substrate. Those pores respectively have a first unoccupied pore volume. Pores in a second portion of the substrate respectively have a second unoccupied pore volume. The first unoccupied pore volume is less than the second unoccupied pore volume.

In an example embodiment having one or more features of the fuel cell of the previous paragraph, the first portion of the substrate is in a condensation zone of the fuel cell.

In an example embodiment having one or more features of the fuel cell of any of the previous paragraphs, the matrix includes a plurality of matrix pores, the matrix pores respectively have a third unoccupied pore volume, and the third unoccupied pore volume is less than the first unoccupied pore volume.

In an example embodiment having one or more features of the fuel cell of any of the previous paragraphs, the pores having the liquid electrolyte absorbing material respectively have a first resulting pore size, the pores in the second portion of the substrate respectfully have a second pore size that is on average about 20 μm, the matrix includes a plurality of matrix pores, the matrix pores respectively have a third pore size that is on average about 1.8 μm, the first pore size is greater than the third pore size, and the first pore size is less than the second pore size.

In an example embodiment having one or more features of the fuel cell of any of the previous paragraphs, the substrate is planar, at least the first portion of the substrate has a through plane conductivity and an in-plane conductivity, and the through plane conductivity is higher than the in-plane conductivity.

In an example embodiment having one or more features of the fuel cell of any of the previous paragraphs, the liquid electrolyte absorbing material comprises carbon.

In an example embodiment having one or more features of the fuel cell of any of the previous paragraphs, the liquid electrolyte absorbing material comprises graphite.

In an example embodiment having one or more features of the fuel cell of any of the previous paragraphs, the first portion of the substrate is impregnated with the liquid electrolyte absorbing material.

An example embodiment having one or more features of the fuel cell of any of the previous paragraphs includes another substrate adjacent the anode electrode. That substrate has a first portion and second portion as described above.

In an example embodiment having one or more features of the fuel cell of any of the previous paragraphs, the first portion of the substrate has a first density, the second portion of the substrate has a second density, and the first density is greater than the second density.

In an example embodiment having one or more features of the fuel cell of any of the previous paragraphs, the first portion of the substrate is located near a cathode exhaust of the fuel cell.

Various features and advantages of at least one disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates a fuel cell designed according to an embodiment of this invention.

FIG. 2 schematically illustrates selected features of an example fuel cell substrate designed according to an embodiment of this invention.

FIG. 3 is a flowchart diagram summarizing an example method of making a fuel cell component designed according to an embodiment of this invention.

### DETAILED DESCRIPTION

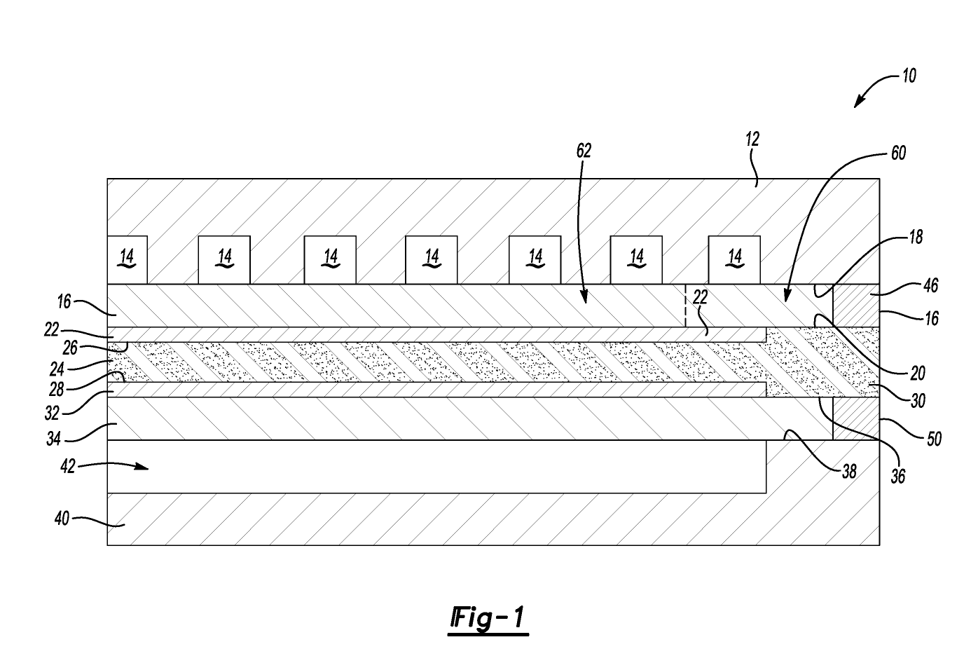

A liquid electrolyte fuel cell 10 is schematically represented in FIG. 1. Components of an individual cell are illustrated. Those skilled in the art understand how a stack of such cells are assembled into a fuel cell stack assembly.

The fuel cell 10 includes an oxidant flow plate 12 that is configured for directing an oxidant reactant stream flow through the fuel cell 10 through a plurality of oxidant flow channels 14 that are established or defined within the oxidant flow plate 12. A cathode substrate layer 16 has oppositely facing contact surfaces 18 and 20. The contact surface 18 is situated adjacent the plurality of oxidant flow channels 14 of the oxidant flow plate 12. A cathode catalyst layer 22 is situated adjacent the contact surface 20 of the cathode substrate layer 16.

A matrix 24 has oppositely facing surfaces 26 and 28. The matrix 24 is configured for retaining a liquid electrolyte schematically represented at 30. In some embodiments, the liquid electrolyte comprises phosphoric acid. The contact surface 26 of the matrix 24 is situated adjacent the cathode catalyst layer 22.

An anode catalyst layer 32 is situated against the other contact surface 28 of the matrix 24. An anode substrate layer 34 has oppositely facing contact surfaces 36 and 38. The contact surface 36 is situated adjacent the anode catalyst layer 32.

A fuel flow plate 40 that includes a plurality of fuel flow channels 42 is situated adjacent the contact surface 38 of the anode substrate layer 34. The fuel flow channel 42 is adjacent the contact surface 38 of the substrate 34 for directing a flow of fuel reactant into pores of the anode substrate layer 34 so that the fuel reaches the anode catalyst layer 32.

To prohibit gaseous reactant streams from undesirably escaping the substrate layers, the cathode substrate layer 16 includes an edge seal 46 and the anode substrate layer 34 includes an edge seal 50. The edge seals 46 and 50 also prevent undesirable movement of a liquid electrolyte or liquid byproducts out of a perimeter of the fuel cell 10. Such edge seals are generally known.

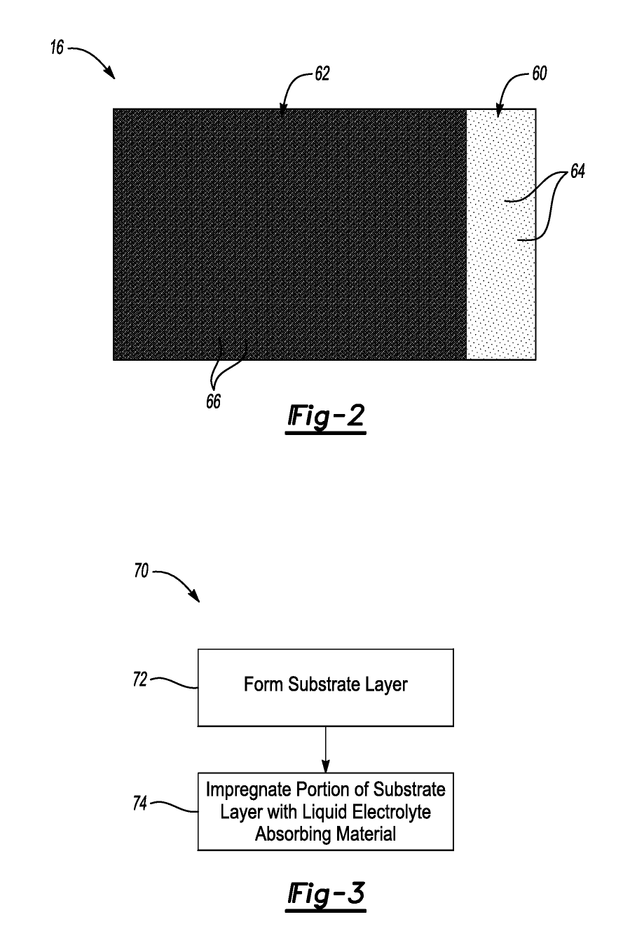

Referring to FIGS. 1 and 2, the cathode substrate 16 has a first portion 60 and a second portion 62. The first portion 60 is impregnated with a liquid electrolyte absorbing material. In particular, pores 64 within the first portion 60 are at least partially filled with the liquid electrolyte absorbing material. The second portion 62 includes pores 66 that do not contain the liquid electrolyte absorbing material.

The presence of the liquid electrolyte absorbing material within the pores 64 leaves them with a resulting pore size or unoccupied pore volume that is different than the pore size or unoccupied pore volume of the pores 66 in the second portion 62. In this example, a first unoccupied pore volume of the pores 64 resulting from the impregnation with the liquid electrolyte absorbing material is less than a second unoccupied pore volume of the pores 66. In other words, the resulting first pore size of the pores 64 is less than the second pore size of the pores 66.

FIG. 3 is a flowchart diagram 70 summarizing an example method of making the fuel cell component, such as the substrate 16. The substrate layer is formed at 72. The first portion of the substrate layer is impregnated with liquid electrolyte absorbing material at 74. The pores 64 in the first portion 60 have the same pore size as the pores 66 after the substrate layer is formed at 72. When the liquid electrolyte absorbing material effectively fills at least a portion of at least some of the pores 64 in the first portion 60 the result is the smaller pore size of those pores 64.

The first pore size of the pores 64 in the first portion 60 that have liquid electrolyte absorbing material within them is between the size of the pores 66 of the second portion 62 and the size of matrix pores of the matrix layer 24. In one example embodiment, the average pore size of the pores 66 is about 20 micrometers and the average pore size of the matrix pores of the matrix layer 24 is about 1.8 micrometers. The resulting pore size of the pores 64 after the impregnating with the liquid electrolyte absorbing material is between the average pore size of the pores 66 and the average pore size of the matrix pores. Keeping the pore size or unoccupied pore volume of the pores 64 larger than that of the matrix pores increases the tendency of the liquid electrolyte to enter those pores 64 in the first portion 60.

In an example embodiment, the liquid electrolyte absorbing material comprises carbon. In some embodiments, the liquid electrolyte absorbing material that is impregnated into the first portion 60 of the substrate 16 comprises graphite.

The substrate 16 is discussed above as an example and the anode substrate 34 in some embodiments also includes a first portion 60 and a second portion 62 having the features described above.

Given the presence of the liquid electrolyte absorbing material within at least some of the pores 64 of the first portion 60, the substrate layer is more solid or has an increased density in the first portion 60 compared to the second portion 62.

While the first portion 60 in FIG. 2 is shown near one end of the substrate 16, a distribution of the first portion 60 may be different in other embodiments. One feature of having the first portion 60 configured like that shown in FIG. 2 is that the first portion 60 may be situated within a condensation zone of the fuel cell 10. Another feature of having a first portion 60 configured like that shown in FIG. 2 is that the first portion 60 may be situated adjacent a cathode exhaust portion of the fuel cell 10.

With the first portion 60 in the condensation zone of the fuel cell, higher through plane conductivity exists at the location of the first portion 60. This increased through plane conductivity results from the liquid electrolyte absorbing material absorbing or retaining liquid electrolyte in the first portion 60 of the substrate 16. Given that a liquid electrolyte, such as phosphoric acid, has a much higher conductivity than gas (e.g., about thirty times that of gas), the additional liquid electrolyte improves the thermal conductivity of the substrate layer 16. This feature leads to a lower cathode exhaust temperature when the first portion 60 is situated near the cathode exhaust of the fuel cell 10. Reducing cathode exhaust temperature leads to lower acid loss rates and improved fuel cell performance and longevity.

The impregnated first portion 60 facilitates improved fuel cell life and performance by reducing the temperature at the air exit (e.g., the cathode exhaust), increases heat transfer in the through plane direction while reducing heat transfer in the in-plane direction and increases liquid electrolytes storage capacity even though the porosity of the first portion 60 is decreased compared to that of the second portion 62. The impregnated first portion 60 reduces acid evaporation, which contributes to increased fuel cell life and improved fuel cell performance

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A fuel cell component, comprising
an electrode substrate including a plurality of pores, a first portion of the substrate including a liquid electrolyte absorbing material in at least some of the pores in the first portion of the substrate, the at least some of the pores in the first portion respectively having a first unoccupied pore volume, pores in a second portion of the substrate respectively having a second unoccupied pore volume, the first unoccupied pore volume being less than the second unoccupied pore volume.

2. The fuel cell component of claim 1, wherein the liquid electrolyte absorbing material comprises carbon.

3. The fuel cell component of claim 1, wherein the liquid electrolyte absorbing material comprises graphite.

4. The fuel cell component of claim 1, wherein the first portion of the substrate is impregnated with the liquid electrolyte absorbing material.

5. The fuel cell component of claim 1, wherein
the pores in the second portion of the substrate have an average pore size of about 20 micrometers; and
the at least some of the pores having the liquid electrolyte absorbing material have an average resulting pore size greater than about 2 micrometers and less than about 20 micrometers.

6. A method of making a fuel cell component, the method comprising:
forming a substrate having a plurality of pores; and
impregnating at least a first portion of the substrate with a liquid electrolyte absorbing material such that at least some of the pores within the first portion of the substrate respectively have a first unoccupied pore volume and the pores in a second portion of the substrate respectively have a second unoccupied pore volume, wherein the first unoccupied pore volume is less than the second unoccupied pore volume.

7. The method of claim 6, wherein the liquid electrolyte absorbing material comprises carbon.

8. The method of claim 6, wherein the liquid electrolyte absorbing material comprises graphite.

9. The method of claim 6, wherein
the pores in the second portion of the substrate have an average pore size of about 20 micrometers; and
the at least some of the pores in the first portion having the liquid electrolyte absorbing material have an average resulting pore size greater than about 2 micrometers and less than about 20 micrometers after the impregnating.

10. A fuel cell, comprising:
a matrix configured to contain a liquid electrolyte;
a cathode electrode on one side of the matrix;
an anode electrode on an opposite side of the matrix; and
a substrate adjacent the cathode electrode, the substrate having a plurality of pores, a first portion of the substrate including a liquid electrolyte absorbing material in at least some of the pores in the first portion of the substrate, the at least some of the pores in the first portion respectively having a first unoccupied pore volume, pores in a second portion of the substrate respectively having a second unoccupied pore volume, the first unoccupied pore volume being less than the second unoccupied pore volume.

11. The fuel cell of claim 10, wherein the first portion of the substrate is in a condensation zone of the fuel cell.

12. The fuel cell of claim 10, wherein
the matrix includes a plurality of matrix pores;
the matrix pores respectively have a third unoccupied pore volume; and
the third unoccupied pore volume is less than the first unoccupied pore volume.

13. The fuel cell of claim 10, wherein
the at least some of the pores having the liquid electrolyte absorbing material respectively have a first resulting pore size;
the pores in the second portion of the substrate respectively have a second pore size that is on average about 20 micrometers;
the matrix includes a plurality of matrix pores;
the matrix pores respectively have a third pore size that is on average about 1.8 micrometers;
the first pore size is greater than the third pore size; and
the first pore size is less than the second pore size.

14. The fuel cell of claim 10, wherein
the substrate is planar;
at least the first portion of the substrate has a through plane conductivity and an in-plane conductivity; and
the through plane conductivity is higher than the in-plane conductivity.

15. The fuel cell of claim 10, wherein the liquid electrolyte absorbing material comprises carbon.

16. The fuel cell of claim 10, wherein the liquid electrolyte absorbing material comprises graphite.

17. The fuel cell of claim 10, wherein the first portion of the substrate is impregnated with the liquid electrolyte absorbing material.

18. The fuel cell of claim 10, comprising another said substrate adjacent the anode electrode.

19. The fuel cell of claim 10, wherein
the first portion of the substrate has a first density;
the second portion of the substrate has a second density; and
the first density is greater than the second density.

20. The fuel cell of claim 10, wherein the first portion of the substrate is located near a cathode exhaust of the fuel cell.
